(19) United States
(12) Patent Application Publication
(10) Pub. No.: US 2006/0251892 A1
(43) Pub. Date: Nov. 9, 2006

(54) Anti-static self-adhesive strip

(76) Inventors: Marc Husemann, Hamburg (DE); Stephan Zollner, Hamburg (DE)

Correspondence Address: NORRIS, MCLAUGHLIN & MARCUS, P.A., 875 THIRD AVE, 18TH FLOOR, NEW YORK, NY, 10022, US

(21) Appl. No.: 10/537,440

(22) PCT Filed: Nov. 11, 2003
(86) PCT No.: PCT/EP03/12545

§ 371 Date: Feb. 28, 2006

(30) Foreign Application Priority Data
Dec. 4, 2002 (DE) 10256515.5

(51) Int. Cl. B32B 7/12; B32B 15/04

(52) U.S. Cl. 428/354; 428/343

(57) ABSTRACT

The invention relates to single- or double-sided anti-static self-adhesive strip, made from a support material with an electrically-conducting primer and a self-adhesive material layer, a supporting material, an electrically-conducting primer and two self-adhesive material layers or a support material, two electrically-conducting primers and two self-adhesive layers. The electrically conducting layer can comprise electrically-conducting particles, preferably made from metal, electrically-doped materials, or electrically-conducting polymers.

The invention relates to a single- or double-sided antistatic pressure-sensitive adhesive tape of multilayer construction from a carrier layer and at least one pressure-sensitive adhesive layer.

Pressure-sensitive adhesive tapes in the age of industrialization are widespread processing aids. Particularly for use in the computer industry such tapes are subject to very stringent requirements. In addition to low outgassing, the pressure-sensitive adhesive tapes ought to be capable of use within a wide temperature range and ought not to produce any electrical charge following removal. This electrical charge may greatly damage especially highly sensitive electrical equipment. These requirements are essential, for example, for the bonding of silicon wafers. There is therefore a large demand for antistatic pressure-sensitive adhesive tapes. One specific example of an antistatic pressure-sensitive adhesive tape is described in U.S. Pat. No. 6,255,423, for example.

As well as in the computer industry, however, antistatic pressure-sensitive adhesive tapes can also be employed very effectively for repositionable bonds. The problem which generally exists here is that, again, following the removal of the customary pressure-sensitive adhesive tape, charges are formed which make renewed bonding more difficult, since the pressure-sensitive adhesive tape is then electrostatically repelled by the substrate. This problem is exacerbated when pressure-sensitive adhesive tapes are used that have a thin, lightweight carrier material and a low adhesive application rate. The problem can be solved by means of antistatic pressure-sensitive adhesive tapes.

Generally speaking, antistatic pressure-sensitive adhesive tapes are produced using antistatic carrier materials. Examples of antistatic carrier materials are described in U.S. Pat. No. 5,108,463, U.S. Pat. No. 5,137,542, U.S. Pat. No. 5,328,716 and U.S. Pat. No. 5,560,753, for example. These carrier materials, however, are too expensive. The properties which a carrier material is required to meet can be achieved more simply and cost-effectively with other materials. It is therefore not advantageous to produce the carrier from conductive material.

U.S. Pat. No. 3,163,968 describes a pressure-sensitive adhesive tape which carries graphite as electrically conductive material on its surface and therefore possesses antistatic properties. U.S. Pat. No. 3,377,264 claims an electrically conductive layer of metal or a metal foil. U.S. Pat. No. 5,061,294 claims doped conjugated polymers for electrical conductivity and hence for increasing the antistatic properties.

Conductive layers applied to the surface of the pressure-sensitive adhesive tape, or conductive materials incorporated into the pressure-sensitive adhesive, however, affect the adhesive properties of the pressure-sensitive adhesive, which is an unwanted effect.

U.S. Pat. No. 3,942,959 describes electrically conductive resins present in a sandwich construction between two resin layers that are not electrically conductive. To improve the electrical conductivity, metal pigments, metal salts or metal alloys are used. The result is a very complicated coating process.

It is an object of the invention, therefore, to provide antistatic pressure-sensitive adhesive tapes which avoid the disadvantages of the prior art.

To achieve this object it is envisaged, for a pressure-sensitive adhesive tape of the type specified at the outset, to dispose at least one additional electrically conductive layer between the carrier layer and a pressure-sensitive adhesive layer.

The invention is based on the idea of treating the carrier with an electrically conductive primer, in other words providing an electrically conductive additional layer on the carrier, over which a pressure-sensitive adhesive layer is then placed. This measure may be implemented on one side, on both sides or else only on parts of the carrier.

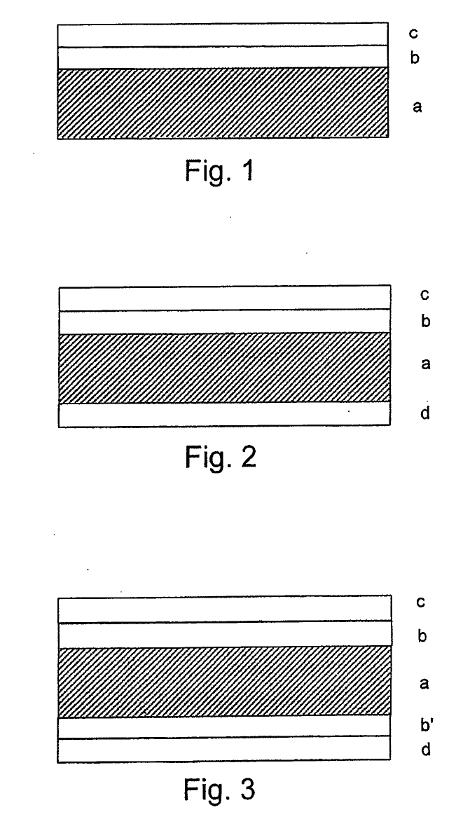

The invention accordingly provides single- or double-sided antistatic pressure-sensitive adhesive tapes which, as shown in more detail below in connection with FIG. 1, are composed of a carrier material with an electrically conductive primer and a pressure-sensitive adhesive layer; according to FIG. 2, are composed of a carrier material with an electrically conductive primer and two pressure-sensitive adhesives; and according to FIG. 3 are composed of a carrier material having two electrically conductive primers and two pressure-sensitive adhesives.

The electrically conductive layer may include electrically conductive particles, preferably of metal, electrically doped materials or electrically conductive polymers. These electrically conductive particles may be embedded, for example, in polymers. The fraction of these particles is preferably 5% to 60% by weight, more preferably 10% to 50% by weight.

The electrically conductive layer may likewise include homogeneously distributed electrically conductive materials, preferably electrically doped materials, electrically conductive polymers or electrically conductive organic salts, in an amount of preferably 5% to 60%, more preferably 10% to 50% by weight.

Particular preference is given to the use of electrically conductive conjugated polymers in the electrically conducting primer layer, and especially of 3,4-PEDT.

In one advantageous version, pressure-sensitive adhesives having a resilience are used. These pressure-sensitive adhesives are also referred to below as anisotropically oriented, or as oriented, pressure-sensitive adhesives.

Anisotropically oriented pressure-sensitive adhesives possess a tendency, after stretching in a given direction, to move back into the initial state as a result of what is termed their “entropy-elastic behavior”.

In one preferred version the pressure-sensitive adhesive applied to the electrically conductive primer possesses a shrinkback. The shrinkback can be determined according to test B via the shrinkback in the free film and should amount at least to more than 3%. Preferred developments use pressure-sensitive adhesives for which the shrinkback is at least 30%, very preferably at least 50%.

Pressure-sensitive adhesive (PSA) systems used for the inventive antistatic pressure-sensitive adhesive tapes are acrylate, natural rubber, synthetic rubber, silicone or EVA adhesives and particular advantage within this group is possessed by the acrylate PSAs. Naturally, however, the process can also be used to process all other PSAs known to the skilled worker, as are listed, for example, in the “Handbook of Pressure Sensitive Adhesive Technology” by Donatas Satas (van Nostrand, New York,1989).

For natural rubber adhesives the natural rubber is ground to a molecular weight (weight average) of not below about 100 000 daltons, preferably not below 500 000 daltons, and additized.

In the case of rubber/synthetic rubber as a starting material for the adhesive, there are further possibilities for variation, whether it be from group of the natural rubbers or the synthetic rubbers or whether it be from any blend of natural rubbers and/or synthetic rubbers, it being possible for the natural rubber or rubbers to be chosen in principle from all available grades such as, for example, crepe, RSS, ADS, TSR or CV types, depending on required level of purity and viscosity, and for the synthetic rubber or rubbers to be chosen from the group consisting of randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate (EVA) copolymers and polyurethanes and/or blends thereof.

With further preference it is possible, in order to improve the processing properties of the rubbers, to add to them thermal elastomers with a weight fraction of 10% to 50% by weight, based on the total elastomer fraction. Representatives that may be mentioned at this point include in particular the especially compatible styrene-isoprene-styrene (SIS) and styrene-butadiene-styrene (SBS) types.

In one version which is particularly preferred inventively it is preferred to use (meth)acrylate PSAs.

(Meth)acrylate PSAs, which are obtainable by free-radical addition polymerization, are composed of at least 50% by weight of at least one acrylic monomer from the group of the compounds of the following general formula: 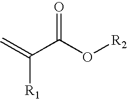
where R₁═H or CH₃ and the radical R₂═H or CH₃ or is chosen from the group of the branched or unbranched, saturated alkyl groups having 1-30 carbon atoms.

The monomers are preferably chosen such that the resulting polymers can be used, at room temperature or higher temperatures, as PSAs, and more particularly such that the resulting polymers possess properties of pressure-sensitive adhesion in accordance with the “Handbook of Pressure Sensitive Adhesive Technology” by Donatas Satas (van Nostrand, New York 1989).

In a further inventive version the comonomer composition is chosen such that the PSAs can be used as heat-activable PSAs.

In a further version of the invention it is possible as well to use electrically conductive PSAs.

The molar masses M_{w} of the polyacrylates used are preferably ≧200 000 g/mol.

With great preference use is made of acrylic or methacrylic monomers which are composed of acrylic and methacrylic esters having alkyl groups of 4 to 14 carbon atoms, and preferably comprise 4 to 9 carbon atoms. Specific examples, without wishing to be restricted by this enumeration, are methyl acrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, and their branched isomers, such as isobutyl acrylate, 2-ethylhexyl acrylate, 2-ethylhexyl methacrylate, isooctyl acrylate and isooctyl methacrylate, for example.

Further classes of compound which can be used are monofunctional acrylates and/or methacrylates of bridged cycloalkyl alcohols, consisting of at least 6 carbon atoms. The cycloalkyl alcohols may also be substituted, by C-1-6 alkyl groups, halogen atoms or cyano groups, for example. Specific examples are cyclohexyl methacrylates, isobornyl acrylate, isobornyl methacrylates and 3,5-dimethyladamantyl acrylate.

In one procedure use is made of monomers which carry polar groups such as carboxyl radicals, sulfonic and phosphonic acid, hydroxyl radicals, lactam and lactone, N-substituted amide, N-substituted amine, carbamate, epoxy, thiol, alkoxy and cyano radicals, ethers or the like.

Moderate basic monomers are, for example, N,N-dialkyl-substituted amides, such as, for example, N,N-dimethylacrylamide, N,N-dimethylmethylmethacrylamide, N-tert-butylacrylamide, N-vinylpyrrolidone, N-vinyllactam, dimethylaminoethyl methacrylate, dimethylaminoethyl acrylate, diethylaminoethyl methacrylate, diethylaminoethyl acrylate, N-methylolmethacrylamide, N-(buthoxymethyl)methacrylamide, N-methylolacrylamide, N-(ethoxymethyl)acrylamide and N-isopropylacrylamide, this enumeration not being exhaustive.

Further preferred examples are hydroxyethyl acrylate, hydroxypropyl acrylate, hydroxyethyl methacrylate, hydroxypropyl methacrylate, allyl alcohol, maleic anhydride, itaconic anhydride, itaconic acid, glyceridyl methacrylate, phenoxyethyl acrylate, phenoxyethyl methacrylate, 2-butoxyethyl methacrylate, 2-butoxyethyl acrylate, cyanoethyl methacrylate, cyanoethyl acrylate, glyceryl methacrylate, 6-hydroxyhexyl methacrylate, vinylacetic acid, tetrahydrofurfuryl acrylate, β-acryloyloxypropionic acid, trichloroacrylic acid, fumaric acid, crotonic acid, aconitic acid, and dimethylacrylic acid, this enumeration not being exhaustive.

In one further very preferred procedure the monomers used include vinyl esters, vinyl ethers, vinyl halides, vinylidene halides, and vinyl compounds with aromatic rings and heterocycles in α position. Here again, mention may be made, not exclusively, of certain examples: vinyl acetate, vinylformamide, vinylpyridine, ethyl vinyl ether, vinyl chloride, vinylidene chloride and acrylonitrile.

Moreover, in a further procedure, use is made of photoinitiators having a copolymerizable double bond. Suitable photoinitiators include Norrish I and II photoinitiators. Examples are, e.g., benzoin acrylate and an acrylated benzophenone from UCB (Ebecryl P 36®). In principle it is possible to copolymerize any photoinitiators which are known to the skilled worker and which are able to crosslink the polymer by way of a free-radical mechanism under UV irradiation. An overview of possible photoinitiators which can be used and which can be functionalized with a double bond is given in Fouassier: “Photoinitiation, Photopolymerization and Photocuring: Fundamentals and Applications”, Hanser-Verlag, Munich 1995. As a supplementary source, Carroy et al. in “Chemistry and Technology of UV and EB Formulation for Coatings, Inks and Paints”, Oldring (ed.), 1994, SITA, London is used.

In a further preferred procedure the comonomers described are admixed with monomers which possess a high static glass transition temperature. Suitable components include aromatic vinyl compounds, such as styrene, for example, where preferably the aromatic nuclei are composed of C₄ to C₁₈ units and may also contain heteroatoms. Particularly preferred examples are 4-vinylpyridine, N-vinylphthalimide, methylstyrene, 3,4-dimethoxystyrene, 4-vinylbenzoic acid, benzyl acrylate, benzyl methacrylate, phenyl acrylate, phenyl methacrylate, t-butylphenyl acrylate, t-butylphenyl methacrylate, 4-biphenylyl acrylate and methacrylate, 2-naphthyl acrylate and methacrylate, and mixtures of those monomers, this enumeration not being exhaustive.

For further development it is possible to admix resins to the PSAs. As tackifying resins for addition it is possible without exception to use all existing tackifier resins and those described in the literature. Representatives that may be mentioned include pinene resins, indene resins and rosins, their disproportionated, hydrogenated, polymerized and esterified derivatives and salts, the aliphatic and aromatic hydrocarbon resins, terpene resins and terpene-phenolic resins, and also C5, C9 and other hydrocarbon resins. Any desired combinations of these and further resins may be used in order to adjust the properties of the resultant adhesive in accordance with requirements. Generally speaking it is possible to employ any resins with are compatible (soluble) with the polyacrylate in question; in particular, reference may be made to all aliphatic, aromatic and alkylaromatic hydrocarbon resins, hydrocarbon resins based on single monomers, hydrogenated hydrocarbon resins, functional hydrocarbon resins, and natural resins. Express reference may be made to the depiction of the state of the art in the “Handbook of Pressure Sensitive Adhesive Technology” by Donatas Satas (van Nostrand, 1989).

In addition it is possible optionally to add plasticizers, further fillers (such as, for example, fibers, carbon black, zinc oxide, chalk, solid or hollow glass beads, microbeads of other materials, silica, silicates), nucleators, electrically conductive materials, such as conjugated polymers, doped conjugated polymers, metal pigments, metal particles, metal salts, graphite, etc., expandants, compounding agents and/or aging inhibitors, in the form for example of primary and secondary antioxidants or in the form of light stabilizers.

In addition it is possible to admix crosslinkers and crosslinking promoters. Examples of suitable crosslinkers for electron-beam crosslinking and UV crosslinking include difunctional or polyfunctional acrylates, difunctional or polyfunctional isocyanates (including those in blocked form) or difunctional or polyfunctional epoxides.

For optional crosslinking with UV light it is possible to add UV-absorbing photoinitiators to the polyacrylate PSAs. Useful photoinitiators whose use is very effective are benzoin ethers, such as benzoin methyl ether and benzoin isopropyl ether, substituted acetophenones, such as 2,2-diethoxyacetophenone (available as Irgacure 651® from Ciba Geigy®), 2,2-dimethoxy-2-phenyl-1-phenylethanone, dimethoxyhydroxyacetophenone, substituted α-ketols, such as 2-methoxy-2-hydroxypropiophenone, aromatic sulfonyl chlorides, such as 2-naphthylsulfonyl chloride, and photoactive oximes, such as 1-phenyl-1,2-propanedione 2-(O-ethoxycarbonyl) oxime, for example.

The abovementioned photoinitiators and others which can be used, and others of the Norrish I or Norrish II type, may contain the following radicals: benzophenone-, acetophenone-, benzo-, benzoin-, hydroxyalkylphenone-, phenyl cyclohexyl ketone-, anthraquinone-, trimethylbenzoylphosphine oxide-, methylthiophenyl morpholine ketone-, aminoketone-, azobenzoin-, thioxanthone-, hexarylbisimidazole-, triazine-, or fluorenone, it being possible for each of these radicals to be additionally substituted by one or more halogen atoms and/or one or more alkyloxy groups and/or by one or more amino groups or hydroxyl groups. A representative overview is given by Fouassier: “Photoinitiation, Photopolymerization and Photocuring: Fundamentals and Applications”, Hanser-Verlag, Munich 1995. For further details it is possible to consult Carroy et al. in “Chemistry and Technology of UV and EB Formulation for Coatings, Inks and Paints”, Oldring (ed.), 1994, SITA, London.

Electrically Conductive Primer

The electrically conductive primer is applied single- or double-sidedly to a carrier material. Suitable carrier materials include, with particular preference, films consisting of polymeric materials, such as PE, PP, polyimides, polyamides, BOPP, PET, PVC, PU or nylon, for example. It is also, however, possible to treat nonwovens or woven fabrics.

Examples of substances suitable in principle as the base substance for the primer include phenolic resins with at least one rubber component.

As the rubber component it is possible to use natural rubbers, butyl rubbers and numerous synthetic rubbers, mention be made only by way of example of acrylonitrile-butadiene, acrylonitrile-butadiene-styrene copolymers, styrene-butadiene-styrene, styrene-ethylene, butylene-styrene copolymers, polychloroprene, polybutadiene, polyisoprene, styrene-isoprene-styrene copolymers, and mixture thereof.

Useful phenolic resins include, for example, phenol-formaldehyde resins, available commercially from Union Carbide under the trade names UCAR BKR-2620 and UCAR CK-1635. Preferred primers contain, for example, 40 to about 120 parts of phenol resin to 100 parts of rubber component.

In a further preferred version poly(meth)acrylates are used as primer materials. The primers may comprise further additives such as resins, antioxidants and dyes, for example.

A further constituent of the primer is an electrically conductive material. As electrically conductive materials it is possible, without being restricted by this enumeration, to use metal particles, metal powders and/or metal pigments, metal beads, metal fibers, of metals such as, for example, nickel, gold, silver, iron, lead, tin, zinc, stainless steel, bronze and copper or nickel. Additionally useful are, for example, lead/tin alloys having different compositions, as offered, for example, by Sherrit Gordon, Ltd. Moreover, electrically conductive polymers are used, such as polythiophene, substituted polythiophenes, polyethylenedioxythiophenes, polyaniline, substituted polyanilines, polyparaphenylene, substituted polyparaphenylenes, polypyrrole, substituted polypyrroles, polyacetylenes, substituted polyacetylenes, polyphenyl sulfides, substituted polyphenyl sulfides, polyfurans, substituted polyfurans, polyalkylfluorene, substituted polyalkylfluorenes, and mixtures of the abovementioned polymers. To improve the conductivity it is possible to add what are called dopants. Here it is possible to use various metal salts or Lewis acid or electrophils. Examples, without possessing any claim to completeness, are p-toluenesulfonic acid or camphorsulfonic acid.

In a further preferred inventive version the diameter of the electrically conductive fillers is smaller than the layer thickness of the primer.

Electrically conductive materials which can be added in a further version are carbon compounds, such as C-60, for example. With these compounds as well it is possible, by means of controlled doping, to achieve an improvement in the electrical conductivity. Further electrically conductive polymers include polyvinylbenzyltrimethylammonium chloride and similar compounds, as cited in U.S. Pat. No. 5,061,294, for example.

In addition it is also possible, however, to use hygroscopic salts as electrically conductive substances, as are described in U.S. Pat. No. 4,973,338.

In one very preferred version, ethylenedioxythiophene is polymerized with an iron(III) salt in an acrylate dispersion. This primary dispersion is subsequently applied to the carrier material and dried.

Electrically conductive materials are added at 3-60 weight percent, more preferably between 10 and 50 weight percent, based on the primer, the addition taking place in particular in solid form, e.g., pulverized form.

The fraction should not, however, exceed an amount such that the primer loses its effect. As a result of excessive proportions of electrically conductive substance it is possible for the electrically conductive primer to lose its adhesion promotion effect.

The layer thickness of the electrically conductive primer is between 0.5 μm and 25 μm, preferably between 1 and 10 μm.

Electrically conductive primers may be coated from solution, from dispersion or from the melt. In order to increase the internal cohesion it may be of advantage to crosslink the primer. Crosslinking may take place thermally, via UV radiation or via electron beams.

Preparation Processes for the Acrylate PSAs

For the polymerization the monomers are chosen such that the resultant polymers can be used at room temperature or higher temperatures as PSAs, and particularly such that the resultant polymers possess pressure-sensitive adhesion properties in accordance with the “Handbook of Pressure Sensitive Adhesive Technology” by Donatas Satas (van Nostrand, New York 1989).

In order to achieve a glass transition temperature, T_{g}, of the polymers that is preferred for PSAs, namely T_{g}≦25° C., it is very preferred, in accordance with what has been said above, to select the monomers, and to choose the quantitative composition of the monomer mixture advantageously, in such a way that in accordance with the Fox equation (E1) (cf. T. G. Fox, Bull. Am. Phys. Soc. 1 (1956) 123) the resulting polymer has the desired T_{g} value.

$$\frac{1}{{T}_{g}} = {\sum }_{n} \frac{{w}_{n}}{{T}_{g , n}} \qquad ( E1 )$$

In this formula, n represents the serial number of the monomers used, wₙ represents the mass fraction of the respective monomer n (% by weight), and T_{g,n} represents the respective glass transition temperature of the homopolymer of each of the monomers n, in K.

For the preparation of the poly(meth)acrylate PSAs it is advantageous to carry out conventional free-radical polymerizations. For the polymerizations which proceed by a free-radical mechanism it is preferred to use initiator systems which additionally comprise further free-radical initiators for the polymerization, especially thermally decomposing, radical-forming azo or peroxo initiators. In principle, however, all customary initiators which are familiar to the skilled worker for acrylates are suitable. The production of C-centered radicals is described in Houben Weyl, Methoden der Organischen Chemie, Vol. E 19a, pp. 60-147. These methods are preferentially employed analogously. Examples of free-radical sources are peroxides, hydroperoxides and azo compounds; some nonlimiting examples of typical free-radical initiators that may be mentioned here include potassium peroxodisulfate, dibenzoyl peroxide, cumene hydroperoxide, cyclohexanone peroxide, di-t-butyl peroxide, azodiisobutyronitrile, cyclohexylsufonyl acetyl peroxide, diisopropyl percarbonate, t-butyl peroctoate and benzpinacole. In one very preferred version a free-radical initiator used is 1,1′-azobis(cyclohexanecarbonitrile) (Vazo 88™ from DuPont) or azodiisobutyronitrile (AIBN).

The average molecular weights M_{w} of the PSAs formed in the free-radical polymerization are very preferably chosen such that they are situated within a range from 200 000 to 4 000 000 g/mol; specifically for further use as electrically conductive hotmelt PSAs with resilience, PSAs having average molecular weights M_{w} of 400 000 to 1 400 000 g/mol are prepared. The average molecular weight is determined via size exclusion chromatography (GPC) or matrix-assisted laser desorption/ionization mass spectrometry (MALDI-MS).

The polymerization may be conducted without solvent, in the presence of one or more organic solvents, in the presence of water, or in mixtures of organic solvents and water. The aim is to minimize the amount of solvent used. Suitable organic solvents are pure alkanes (e.g., hexane, heptane, octane, isooctane), aromatic hydrocarbons (e.g., benzene, toluene, xylene), esters (e.g., ethyl acetate, propyl, butyl or hexyl acetate), halogenated hydrocarbons (e.g., chlorobenzene), alkanols (e.g., methanol, ethanol, ethylene glycol, ethylene glycol monomethyl ether) and ethers (e.g., diethyl ether, dibutyl ether) or mixtures thereof. A water-miscible or hydrophilic cosolvent may be added to the aqueous polymerization reactions in order to ensure that during monomer conversion the reaction mixture is in the form of a homogeneous phase. Cosolvents which can be used with advantage for the present invention are chosen from the following group, consisting of aliphatic alcohols, glycols, ethers, glycol ethers, pyrrolidines, N-alkylpyrrolidinones, N-alkylpyrrolidones, polyethylene glycols, polypropylene glycols, amides, carboxylic acids and salts thereof, esters, organosulfides, sulfoxides, sulfones, alcohol derivatives, hydroxy ether derivatives, amino alcohols, ketones and the like, and also derivatives and mixtures thereof.

The polymerization time amounts, depending on conversion and temperature, to between 2 and 72 hours. The higher the reaction temperature which can be chosen, i.e., the higher the thermal stability of the reaction mixture, the lower the level at which the reaction time can be chosen.

To initiate the polymerization it is essential, for the thermally decomposing initiators, to introduce heat. For the thermally decomposing initiators the polymerization can be initiated by heating to 50 to 160° C., depending on initiator type.

For the preparation it can be also be of advantage to polymerize the (meth)acrylate PSAs without solvent. A particularly suitable technique for use in this case is the prepolymerization technique. The polymerization is initiated with UV light, but taken only to a low conversion of about 10%-30%. Subsequently this polymer syrup can be welded, for example, into films (in the simplest case, ice cubes) and then polymerized through in water to a high conversion. These pellets can then be used as acrylate hotmelt adhesives, it being particularly preferred to use, for the melting operation, film materials which are compatible with the polyacrylate. For this preparation method as well it is possible to add the thermally conductive materials before or after the polymerization.

For preparing the acrylate PSAs it is also possible to employ controlled free-radical polymerization methods and living polymerizations.

Orientation, Coating Processes, Treatment of the Carrier Material

For production, in one preferred version, the PSA is coated from solution. For thermally crosslinking PSAs the solvent is removed and the crosslinking reaction initiated by supply of heat, in a-drying tunnel, for example.

In order to produce oriented PSAs the polymers described above are coated preferably as hotmelt systems (i.e., from the melt). For the production process it may therefore be necessary to remove the solvent from the PSA. In principle it is possible here to use any of the techniques known to the skilled worker. One very preferred technique is that of concentration using a single-screw or twin-screw extruder. The twin-screw extruder may be operated corotatingly or counterrotatingly. The solvent or water is distilled off preferably by way of two or more vacuum stages. Moreover, counterheating is carried out depending on the distillation temperature of the solvent. The residual solvent fractions are preferably <1%, more preferably <0.5% and very preferably <0.2%. The hotmelt is processed further from the melt.

In one preferred embodiment, orientation within the PSA is produced by the coating process. For coating as a hotmelt, and hence also for orientation, it is possible to employ different coating techniques. In one version the electrically conductive PSAs are coated by a roll coating process, and the orientation is produced by drawing. Various roll coating techniques are described in the “Handbook of Pressure Sensitive Adhesive Technology” by Donatas Satas (van Nostrand, New York 1989). In another version the orientation is achieved by coating via a melt die. A distinction can be made here between the contact process and the noncontact process. Orientation of the PSA here can be produced on the one hand within the coating die, by virtue of the die design, or else following emergence form the die, by a drawing operation. The orientation is freely adjustable. The draw ratio can be controlled, for example, by the width of the die gap. Drawing occurs whenever the layer thickness of the PSA film on the carrier material to be coated is less than the width of the die gap.

In another preferred process, the orientation is achieved by extrusion coating. Extrusion coating is preferably performed using an extrusion die. The extrusion dies used may originate with advantage from one of the following three categories: T-dies, fishtail dies, and coathanger dies. The individual types differ in the design of their flow channel. Through the form of the extrusion die it is likewise possible to produce an orientation within the hotmelt PSA. Additionally, here, in analogy to melt die coating, it is likewise possible to obtain an orientation following emergence from the die, by drawing the PSA tape film.

In order to produce oriented (meth)acrylate PSAs it is particularly preferred to carry out coating onto a carrier using a coathanger die, and specifically in such a way that a polymer layer is formed on the carrier by means of a movement of die relative to carrier. The time which elapses between coating and crosslinking is advantageously small. In one preferred procedure, crosslinking is carried out after less than 60 minutes; in a more preferred procedure, after less than 3 minutes; and, in a very preferred procedure, in an inline process, after less than 5 seconds.

The best orientation effects are obtained by deposition onto a cold surface. Consequently the carrier material during coating should be cooled directly by means of a roll. The roll can be cooled by a liquid film/contact film from the outside or inside, or by a coolant gas. The coolant gas may likewise be used to cool the PSA emerging from the coating die. In one preferred procedure the roll is wetted with a contact medium, which is then located between the roll and the carrier material. Preferred embodiments for the implementation of such a technique are described later on below.

For this process it is possible to use both a melt die and an extrusion die. In one very preferred procedure the roll is cooled to room temperature, and in an extremely preferred procedure to temperatures below 10° C. The roll ought to rotate as well.

In a further procedure as part of this production process, the roll is used, moreover, for crosslinking of the oriented PSA.

UV crosslinking is effected by irradiation with shortwave ultraviolet radiation in a wavelength range from 200 to 400 nm, depending on the UV photoinitiator used, especially using high-pressure or medium-pressure mercury lamps at an output of 80 to 240 W/cm. The irradiation intensity is adapted to the respective quantum yield of the UV photoinitiator, the degree of crosslinking to be brought about, and possibly the extent of the orientation.

Moreover, in one preferred version, it is possible to crosslink the PSAs using electron beams. Typical irradiation equipment which may be used includes linear cathode systems, scanner systems and segmented cathode systems, where electron-beam accelerators are concerned. An extensive description of the state of the art and the most important process parameters are found in Skelhorne, Electron Beam Processing, in Chemistry and Technology of UV and EB formulation for Coatings, Inks and Paints, Vol. 1, 1991, SITA, London. The typical accelerator voltages are situated in the range between 50 kV and 500 kV, preferably 80 kV and 300 kV. The scatter doses employed range between 5 to 150 kGy, in particular between 20 and 100 kGy.

It is also possible to employ both crosslinking methods, or other methods which permit high-energy irradiation.

In a further preferred production process, the oriented PSAs are coated onto a roll provided with a contact medium. As a result of the contact medium it is possible in turn to carry out very rapid cooling of the PSA. Advantageously, lamination is then carried out onto the carrier material later.

Furthermore, as the contact medium it is also possible to use a material which has the capacity to bring about contact between the PSA and the roll surface, in particular a material which fills the cavities between carrier material and roll surface (unevennesses in the roll surface, bubbles, for example). In order to implement this technology, a rotating chill roll is coated with a contact medium. In one preferred procedure the contact medium chosen is a liquid, such as water, for example.

Examples of appropriate additives to water as the contact medium include alkyl alcohols such as ethanol, propanol, butanol and hexanol, without wishing to be restricted in the selection of the alcohols as a result of these examples. Also highly advantageous are, in particular, longer-chain alcohols, polyglycols, ketones, amines, carboxylates, sulfonates and the like. Many of these compounds lower the surface tension or raise the conductivity.

A lowering the surface tension may also be achieved by adding small amounts of nonionic and/or anionic and/or cationic surfactants to the contact medium. The most simple way of achieving this is by using commercial washing compositions or soap solutions, preferably in a concentration of a few g/l in water, as the contact medium. Particularly suitable compounds are special surfactants which can be used even at a low concentration. Examples thereof include sulfonium surfactants (e.g., β-di(hydroxyalkyl)sulfonium salt), and also, for example, ethoxylated nonylphenylsulfonic acid ammonium salts or block copolymers, especially diblocks. Here, reference may be made in particular to the state of the art under “surfactants” in Ullmann's Encyclopedia of Industrial Chemistry, Sixth Edition, 2000 Electronic Release, Wiley-VCH, Weinheim 2000.

As contact media it is possible to use the aforementioned liquids, even without the addition of water, in each case alone or in combination with one another.

In order to improve the properties of the contact medium (for example, to increase the shearing resistance, reduce the transfer of surfactants or the like to the liner surface, and thus improved cleaning possibilities for the end product), salts, gels and similar viscosity-enhancing additives may also be added with advantage to the contact medium and/or to the adjuvants employed.

Furthermore, the roll can be macroscopically smooth or can have a surface with a low level of structuring. It has been found appropriate for the roll to possess a surface structure, in particular a surface roughening. This allows wetting by the contact medium to be improved.

The coating process proceeds particularly well if the roll is temperature-controllable, preferably within a range from −30° C. to 200° C., very preferably from 5° C. to 25° C. The contact medium is preferably applied to the roll. A second roll, which takes up the contact medium, may be used for continuous wetting of the coating roll. It is, however, also possible to carry out contactless application, by spraying, for example.

For the variant of the preparation process where the roll is employed simultaneously for use, for example, with electron beams it is common to use a grounded metal roll which absorbs the incident electrons and the X-radiation that is formed thereby.

In order to prevent corrosion, the roll is commonly coated with a protective coat. This coat is preferably selected such that it is wetted effectively by the contact medium. In general, the surface is conductive. It may also be more advantageous, however, to coat it with one or more coats of insulating or semiconducting material.

Where a liquid is used as the contact medium, one outstanding procedure possible is to run a second roll, advantageously having a wettable or absorbent surface, through a bath containing the contact medium, said roll then becoming wetted by or impregnated with the contact medium and applying a film of said contact medium by contact with the roll.

In one preferred procedure the PSA is coated directly on the contact medium roll, and crosslinked. For this purpose it is possible in turn to use the methods and equipment described for UV crosslinking and EB crosslinking. Then, following crosslinking, the PSA is transferred to the primed carrier material. The primed carrier materials already stated may be used.

The characterization of the orientation within the PSAs is dependent on the coating process. The orientation can be controlled, for example, by the die temperature and coating temperature and also by the molecular weight of the polymer.

The degree of orientation is freely adjustable through the die gap width. The thicker the PSA film extruded from the coating die, the greater the extent to which the adhesive can be drawn to a relatively thin PSA film on the carrier material. This drawing operating may be freely adjusted not only by the freely adjustable die width but also by the web speed of the decreasing carrier material.

The orientation of the PSA can be measured with a polarimeter, by infrared dichroism, or using X-ray scattering. It is known that in many cases the orientation in acrylate PSAs in the uncrosslinked state is retained for only a few days. During rest or storage, the system relaxes and loses its preferential direction. As a result of crosslinking after coating, this effect can be strengthened significantly. The relaxation of the oriented polymer chains converges toward zero, and the oriented PSAs can be stored for a very long period of time without loss of their preferential direction.

In one preferred method the measure of the orientation is determined by measuring the shrinkback in the free film (see test B).

Besides the processes described, the orientation may also be produced after coating. In that case, then, a stretchable primed carrier material is preferably used, with the PSA then being drawn during stretching. In this case it is also possible to use PSA coated conventionally from solution or water. In one preferred procedure, then, this drawn PSA is in turn crosslinked with actinic radiation.

Product Constructions

FIG. 1 shows a number of product constructions possible within the framework of the invention:

a) Single-Sided Product Construction

The inventive antistatic PSA tapes are composed of a carrier film layer (a), an electrically conductive primer layer (b), and the PSA layer (c). The layer thickness of the PSA is between 5 μm and 1 mm, preferably between 25 and 200 μm. For use as a PSA tape roll it is possible in one preferred version to line the PSA with a release paper/film. In another preferred version the side of the carrier material that is pointing downward in FIG. 1 is provided with a release coat. In one preferred version, silicone-based or fluorinated polymer release material is employed.

b) Double-Sided Construction

The inventive antistatic PSA tapes are composed of a carrier film layer (a), an electrically conductive primer layer (b), and two PSA layers (c) and (d) (FIG. 2). The layer thickness of the PSAs (c) and (d) is between 5 μm and 1 mm, preferably between 25 and 200 μm. In one very preferred version (c) and (d) are identical. For use as a PSA tape roll, in one very preferred version the PSA tape is lined with a release paper/film.

c) Double-Sided Construction

The inventive antistatic PSA tapes are composed of a carrier film layer (a), two electrically conductive primer layers (b) and (b′), and two PSA layers (c) and (d) (FIG. 3). In one very preferred version (b) and (b′) are identical. The layer thickness of the PSAs (c) and (d) is between 5 μm and 1 mm, preferably between 25 and 200 μm. In one very preferred version (c) and (d) are identical. For use as a PSA tape roll, in one very preferred version the PSA tape is lined with a release paper/film.

Experiments

The invention is illustrated by way of example below by means of experiments.

The following test methods were employed.

Gel Permeation Chromatography GPC (Test A)

The average molecular weight M_{w} and the polydispersity PD were determined by gel permeation chromatography. The eluent used was THF containing 0.1% by volume trifluoroacetic acid. Measurement took place at 25° C. The precolumn used was PSS-SDV, 5 μ, 10³ Å, ID 8.0 mm×50 mm. Separation was carried out using the columns PSS-SDV, 5 μ, 10³ and also 10⁵ and 10⁶ each with ID 8.0 mm×300 mm. The sample concentration was 4 g/l, the flow rate 1.0 ml per minute. Measurement was made against PMMA standards.

Measurement of the Shrinkback (Test B)

Strips with a width of at least 30 mm and a length of 20 cm were cut parallel to the coating direction of the hotmelt. At application rates of 100 g/m², 4 strips were laminated to one another, and at 50 g/m², 8 strips were laminated to one another, so as to give comparable layer thicknesses. The specimen obtained in this way was then cut to a width of exactly 20 mm and was overstuck at each end with paper strips, with a spacing of 15 cm. The test specimen thus prepared was then suspended vertically at RT and the change in length was monitored over time until no further contraction of the sample could be found. The initial length reduced by the final value was then reported, relative to the initial length, as the shrinkback, in percent.

To measure the orientation after a longer time, the coated and oriented PSAs were stored in the form of swatches for a prolonged period and then analyzed.

Antistatic Properties (Test C)

A strip of PSA tape 13 mm wide is unwound at 50 m/min from the PSA tape roll. This PSA tape strip is taken to within 1 cm of the downwardly directed end of an uncharged PET film strip which is hanging straight down and is 30 cm in length, 3 cm in width and 60 μm in thickness. The test is passed if the downwardly hanging film strip is not attracted by the PSA tape and does not stick to it.

Sample Preparation

Polymer 1

A 200 L reactor conventional for free-radical polymerizations was charged with 2400 g of acrylamide, 64 kg of 2-ethylhexyl acrylate, 6.4 kg of N-isopropylacrylamide and 53.3 kg of acetoneisopropanol (95:5). After nitrogen gas had been passed through the reactor for 45 minutes with stirring, the reactor was heated to 58° C. and 40 g of 2,2′-azoisobutyronitrile (AIBN) were added. The external heating bath was then heated to 75° C. and the reaction was carried out constantly at this external temperature. After a reaction time of 1 h a further 40 g of AIBN were added. After 5 h and 10 h, dilution was carried out each time with 15 kg of acetone/isopropanol (95:5). After 6 h and 8 h, 100 g portions of dicyclohexyl peroxydicarbonate (Perkadox 16®, Akzo Nobel) each in solution of 800 g of acetone were added. After a reaction time of 24 h the reaction was terminated and the batch cooled to room temperature. Determination of the molecular weight by test A gave an M_{w}=754 000 g/mol with a polydispersity M_{w}/Mₙ=5.3.

Polymer 2

A 200 L reactor conventional for free-radical polymerizations was charged with 1200 g of acrylamide, 74 kg of 2-ethylhexyl acrylate, 4.8 kg of N-isopropylacrylamide and 53.3 kg of acetoneisopropanol (95:5). After nitrogen gas had been passed through the reactor for 45 minutes with stirring, the reactor was heated to 58° C. and 40 g of 2,2′-azoisobutyronitrile (AIBN) were added. The external heating bath was then heated to 75° C. and the reaction was carried out constantly at this external temperature. After a reaction time of 1 h a further 40 g of AIBN were added. After 5 h and 10 h, dilution was carried out each time with 15 kg of acetone/isopropanol (95:5). After 6 h and 8 h, 100 g portions of dicyclohexyl peroxydicarbonate (Perkadox 16®, Akzo Nobel) each in solution of 800 g of acetone were added. After a reaction time of 24 h the reaction was terminated and the batch cooled to room temperature.

Determination of the molecular weight by test A gave an M_{w}=812 000 g/mol with a polydispersity M_{w}/Mₙ=5.8.

i) Production of Specimens for Determining the Shrinkback

The PSAs in solution were concentrated on a Bersdorff concentrating extruder with a throughput of approximately 40 kg/h at a temperature of approximately 115° C. Following concentration, the residual solvent fraction was less than 0.5% by weight. The composition was then coated onto a 12 μm PET film coated beforehand with 1.5 g/m² silicone (polydimethylsiloxane), application of the composition taking place through a coathanger extrusion die with a die gap of 300 μm and a coating width of 33 cm, at a defined coating temperature (composition temperature) and a web speed of 10 m/min. For an application rate of 50 g/m² (PSA layer approximately 50 μm thick) a draw ratio of 6:1 was set.

The siliconized PET film is passed over a corotating steel roller which is cooled to 5° C. At the point of contact between the PSA film and the PET film, therefore, the PSA film is immediately cooled.

In an inline process, after a web section of approximately 5 m, the PSA tape is then crosslinked with electron beams.

For electron beam irradiation, crosslinking was carried out with an instrument from Electron Crosslinking AB, Halmstad, Sweden. The coated PSA tape was guided through under the Lenard window of the accelerator over a chill roll that is present as a standard feature. Within their radiation zone, the atmospheric oxygen was displaced by flushing with pure nitrogen. The web speed was in each case 10 m/min. Irradiation was carried out with an acceleration voltage of 200 kV.

To determine the shrinkback and therefore to determine the degree of orientation, test B was carried out.

Production of the Primed 12 μm Carrier Film (PET Film)

100 g of polybutyl acrylate dispersion (PLEX 4124 D, Röhm, solids content=59%) are admixed with 20 9 of 3,4-ethylenedioxythiophene (Bayer AG) and 1.5 g of iron(III) p-toluenesulfonate.

The mixture was coated using a coating bar onto a 12 μm thick PET film and dried at room temperature for 1 h and then at 60° C. for 1 h. After drying, the layer thickness of the primer was about 1.5 μm. For double-sided PSA tapes the PET film was also coated double-sidedly with the identical primer and identical layer thickness.

Production of PSA Tapes

ii) Production of Oriented PSA Tapes

A procedure analogous to that under i) was followed. The carrier material used was a PET film 12 μm thick which had been primed beforehand. All of the operating parameters (web speed, coating temperature, draw ratio, polyacrylate PSA, crosslinking dose) were kept constant. To produce the PSA tapes, this PET film was coated, the coating was crosslinked and then the PSA side was lined with a release paper (120 μm polyolefinically (PE) coated paper, siliconized on both sides, 1.4 g/m² polydimethylsiloxane, Loparex, or 100 μm glassine release paper, siliconized on one side). In the second step, the PSA already crosslinked from i) was laminated onto the other side of the PET film, the PSA being pressed on via a roller and the siliconized PET film being subsequently delaminated. Finally, the double-sided PSA tape was wound up.

The second workstep was omitted for the production of only single-sided adhesive specimens.

For double-sided PSA tapes, double-sidedly primer-treated PET films were used; for single-sided tapes, only single-sidedly primer-treated PET films were used, with the PSA then being laminated onto the primed side.

iii) Production of Unoriented PSA Tapes

The PSAs in solution were coated onto a siliconized release paper (120 μm polyolefinically (PE) coated paper, siliconized on both sides, 1.4 g/m² polydimethylsiloxane, Loparex, or 100 μm glassine release paper, siliconized on one side; application method: coating bar). In a drying tunnel the solvent was removed across a number of temperature zones, being heated at 50° C. in the first zone, then at 80° C., and at 100° C. in the last three heating zones. The web speed was 10 m/min. Following the thermal removal of the solvents, the 12 μm PET film was laminated on. In a second step, dissolved PSA was coated in turn onto the PET film of this laminate. The solvent was removed thermally. Finally, the double-sided PSA tape was wound up.

The second workstep was omitted for the production of only single-sided adhesive specimens.

For double-sided PSA tapes, double-sidedly primer-treated PET films were used; for single-sided tapes, only single-sidedly primer-treated PET films were used, with the PSA then being laminated onto the primed side.

PSA Tape (1)

Polymer 1 is concentrated according to i) and according to ii) is coated at 2×100 g/m² onto a 12 μm PET film. The coating temperature was 150° C. Crosslinking was carried out with a 30 kGy EB dose.

PSA Tape (2)

Polymer 1 is blended in solution of 2% by weight of Genomer 4212® (polyurethane diacrylate from Rahn) and with 30% by weight of DT 110 (terpene-phenolic resin from DRT). Then it is concentrated according to i) and according to ii) is coated at 2×100 g/m² onto a 12 μm double-sidedly primer-treated PET film. The coating temperature was 150° C. Crosslinking was carried out with a 70 kGy EB dose.

PSA Tape (3)

Polymer 2 is blended in solution of 2% by weight of Genomer 4212® (polyurethane diacrylate from Rahn), with 30% by weight of Novares TK 90® (C5-C9 hydrocarbon resin from VFT Rüttgers) and 8% by weight of Reofos 65® (oligophosphate from Great Lake Chemicals). Then it is concentrated according to i) and according to ii) is coated at 2×50 g/m² onto a 12 μm double-sidedly primer-treated PET film. The coating temperature was 120° C. Crosslinking was carried out with a 60 kGy EB dose.

PSA Tape (4)

Polymer 1 is coated from solution according to iii) at 2×100 g/m² onto a 12 μm PET film primed on both sides. The drying temperature was not more than 100° C. Crosslinking was carried out with a 30 kGy EB dose.

PSA Tape (5)

Polymer 1 is coated from solution according to iii) at 100 g/m² onto a 12 μm PET film primed on one side. The drying temperature was not more than 100° C. Crosslinking was carried out with a 30 kGy EB dose.

PSA Tape (6)

Polymer 1 is coated from solution according to iii) at 100 g/m² onto a 12 μm PET film. The drying temperature was not more than 100° C. Crosslinking was carried out with a 30 kGy EB dose.

Results

In a first step, 2 polymers were prepared, with an average molecular weight M_{w} of about 800 000 g/mol. These PSAs were used to produce the PSA tapes 1 to 5. Single-sided and double-sided PSA tapes were investigated, the carrier material used being a PET film 12 μm thick and primed with 3,4-polyethylenedioxythiophene. As a reference material, PSA tape 6 was produced, without an electrically conductive primer. In order to investigate the effect of the antistatic treatment, these PSA tapes were analyzed intensively.

In a first analysis the degree of orientation of the individual PSA was determined. Therefore, from the test below, the shrinkback in the free film was determined according to test method B. The measured values are summarized in Table 1.

TABLE 1
Overview of shrinkback values obtained in the free film (test B).

| Example | Shrinkback in the free film (test B) |
|---|---|
| 1 | 66% |
| 2 | 62% |
| 3 | 56% |
| 4 | 0% |
| 5 | 0% |
| 6 | 0% |

The PSAs coated from the melt all exhibit a shrinkback. In contrast, the PSAs coated from solution possess no shrinkback and hence no orientation.

In order to assess the antistatic behavior, test C was carried out. The results are summarized in Table 2 below:

TABLE 2
Overview of investigation of antistatic properties (test C).

| Example | Antistatic properties (test C) |
|---|---|
| 1 | passed |
| 2 | passed |
| 3 | passed |
| 4 | passed |
| 5 | passed |
| 6 | failed |

From the measurements it is apparent that the PSA tapes equipped with the electrically conductive primer all pass the antistatic test. Only the reference specimen 6 fails this test. Moreover, as a result of the construction in accordance with the invention, both single-sided and double-sided PSA tapes can be provided with antistatic properties. Furthermore, the good antistatic properties are not effected by the composition of the PSA. Two different polymers were trialed, and different resin blends were undertaken. In addition, Examples 1-3 can be used to outstanding effect as punched antistatic products.

1. An antistatic pressure-sensitive adhesive tape of multilayer construction comprising a carrier layer, at least one pressure-sensitive adhesive layer, and at least one electrically conductive layer between the carrier layer and a pressure-sensitive adhesive layer.

2. The antistatic pressure-sensitive adhesive tape of claim 1, wherein the electrically conductive layer comprises electrically conductive particles.

3. The antistatic pressure-sensitive adhesive tape of claim 1, wherein the electrically conductive layer comprises homogeneously distributed electrically conductive materials, preferably electrically doped materials, electrically conductive polymers or electrically conductive organic salts, in an amount of preferably 5% to 60%.

4. The antistatic pressure-sensitive adhesive tape of claim 1, wherein the electrically conductive layer comprises electrically conductive conjugated polymers.

5. The antistatic pressure-sensitive adhesive tape of claim 1, wherein the pressure-sensitive adhesive layer comprises a polyacrylate pressure-sensitive adhesive.

6. The antistatic pressure-sensitive adhesive tape of claim 1, wherein the pressure-sensitive adhesive layer exhibits a shrinkback.

7. The antistatic pressure-sensitive adhesive tape of claim 1, comprising the following multilayer construction:
pressure-sensitive adhesive layer/electrically conductive layer/carrier layer.

8. The antistatic pressure-sensitive adhesive tape of claim 1, comprising the following multilayer construction:
pressure-sensitive adhesive layer/electrically conductive layer/carrier layer/electrically conductive layer/pressure sensitive adhesive layer.

9. The antistatic pressure-sensitive adhesive tape of claim 1, comprising the following multilayer construction:
pressure-sensitive adhesive layer/electrically conductive layer/carrier layer/pressure sensitive adhesive layer.

10. The antistatic pressure-sensitive adhesive tape of claim 1 in the form of a punched product.

11. The antistatic pressure-sensitive adhesive tape of claim 2, wherein said electrically conductive particles are particles of a material selected from the group consisting of metal, electrically doped materials or electrically conductive polymers.

12. The antistatic pressure-sensitive adhesive tape of claim 3, wherein said homogeneously distributed electrically conductive materials are selected from the group consisting of electrically doped materials, electrically conductive polymers or electrically conductive organic salts, and are present in an amount of 5% to 60% by weight of the electrically conductive layer.

13. The antistatic pressure-sensitive adhesive tape of claim 12, wherein said electrically conductive materials are present in an amount of 10% to 50% by weight.

14. The antistatic pressure-sensitive adhesive tape of claim 4, wherein said electrically conductive conjugated polymers are 3,4-PEDT.

15. The antistatic pressure-sensitive adhesive tape of claim 5, whereien said polyacrylate is a polymethacrylate.
